(19) United States
(12) Patent Application Publication
(10) Pub. No.: US 2012/0029665 A1
(43) Pub. Date: Feb. 2, 2012

(54) Intelligent Device Control System & Method

(76) Inventor: Tim Perry, St. Louis, MO (US)

(21) Appl. No.: 13/031,452

(22) Filed: Feb. 21, 2011

Related U.S. Application Data
(63) Continuation-in-part of application No. 12/844,617, filed on Jul. 27, 2010, now Pat. No. 7,894,942.

(51) Int. Cl. G06F 17/00

(52) U.S. Cl. 700/90

(57) ABSTRACT

Embodiments of the present invention provide capabilities of ascertaining, distinguishing, responding to, and interacting with usage and/or users of an area. A controller is realizable in a variety of manners, including purpose-built state machines; software realizable controllers engenderable as physically individual or virtual machines; protocols and/or procedures, habitually computer executable, that are integratable or performable by other programs. Among the primary facets of many embodiments of the present invention is the use of an operative motion detector's ongoing lack of a motion detection as actually a positive detection of a lack of motion that provides useful and actionable information. Additional manners of sensing and/or interacting with potential usage are also employed to provide further capacities for intelligent occupancy analysis and response. Many embodiments of the present invention are effectible as at least partially hard-wired and/or at least partially software based alternates, and can include virtual executions.

### CROSS-REFERENCE TO RELATED APPLICATIONS

The present application claims the benefit of the priority dates of each and all of U.S. Provisional Application Ser. No. 60/945,797, filed Jun. 22, 2007; U.S. Non-Provisional application Ser. No. 12/144,154, filed Jun. 23, 2008 (now U.S. Pat. No. 7,765,033); and pending U.S. Non-Provisional application Ser. No. 12/844,617 filed on Jul. 27, 2010; the entire disclosures of each and every one of which is also hereby incorporated completely herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to methods and systems of assessing and responding to occupancy conditions, and more particularly to implementing learning and learned-knowledge employing techniques along with occupancy detection technology to develop and maintain occupancy awareness knowledge for use in various applications including energy conserving purposes.

2. Related Art

Environmental impact mitigation, regulatory strictures, and substantial cost savings are all combining to make improved lighting and equipment control capabilities an ever more pressing need. Automated systems that can detect occupancy conditions and automatically execute appropriate adjustments can accomplish great savings as well as providing other benefits. While many existing occupancy detectors provide considerable performance capabilities, they also often employ elaborate technical approaches that still can't handle certain common challenges. Vexing issues as simple as implementing complete line-of-sight coverage of a women's multi-stall restroom are still not well solved by the conventional approaches, such as the most common tactic that utilizes a limited number of passive infrared (PIR) motion detectors. While an unlimited number of PIR detectors could, in theory, always solve this problem, in the real world nothing is feasibly unlimited, and so an approach that does not require such a massive investment for certainty of performance is needed. One current alternative approach goes as far as mathematically altering a motion detection signal, combining it with a mathematically altered audio signal concocted from a carefully filtered audio microphone's output, and analyzing a combined vector value (derived itself from the mathematically altered signals) for its exhibition of occupancy characteristics all just to solve (actually avoid) the line-of-sight problem.

At the crux of the performance issue for many occupancy detection and control systems is knowledge. The goal for such a system is to automatically, and accurately, know when a given area is occupied, and when it is not. The sooner it knows this information, or acts to attain this information, the more efficiently it can operate. Existing approaches essentially attempt to be sensing at all times. They assume that they are effective enough at detecting motion that given sufficient time any occupant will be detected and that if no occupant is detected then the light can finally be turned off. The existing systems generally don't attain and use occupancy information to achieve major gains, beyond each moment's ephemeral detection status. For the current methodologies, occupancy detection is essentially sensing and immediately forgetting and immediately starting all over again, and again, and again. These existing techniques are somewhat akin to assuming that using better bricks (as opposed to better plans) is the only way one can build a better house. By contrast, the present invention's strategy is similar to building better houses (i.e. better occupancy detection capabilities) by employing better engineering and better architecture, whether the bricks are expensive or not.

### SUMMARY OF THE INVENTION

Among the alternatives to the prior approaches provided by the present invention, termed Intelligent Device Control System & Method (IDCSM), are procedures that render usable more of the information that is at least potentially collectible from detectors. The IDCSM also maintains this information, and knowledge derived from this information, over time and across situations in order to attain and utilize occupancy knowledge, rather than just be limited to reacting to each passing moment's occupancy detector output. One key advantage of many of the embodiments of the present invention are their capacities to derive and utilize more occupancy related information than is garnered by the conventional schemes, even when both are receiving that information from the same detector sources. Many IDCSM embodiments' techniques recognize that distinct and meaningful information is available when the occupancy detectors, normally motion detectors, are not registering an detection as well as when they are.

Rather than treating a lack of detection as an meaningless event, as is generally done currently, many embodiments of the IDCSM recognize that, for example, an occurrence of “motion not detected” is an event in and of itself, and that by incorporating the ramifications of a detection of an absence-of-motion enables substantially greater functional capacities (in contrast to considering a lack of motion detection as the same as a lack of meaningful information.) One significantly useful consequence of being able to recognize a detection of an absence-of-motion is that it can be combined with other information and/or other occupancy related knowledge to attain, maintain, and exploit occupancy knowledge certainty. For example, given the attainment of the knowledge that a particular monitored area is definitely occupied, the ongoing detection of an absence-of-motion confirms that the area is still occupied, since motion would be detected if the occupant left the area. Alternatively, other embodiments of the IDCSM can be aware whether a monitored area's access points have been traversed, or not. For these embodiments, again given the attainment of the knowledge that a particular monitored area is definitely occupied, the ongoing detection of an absence of any access point traversals inherently ascertains that the area remains occupied essentially with certainty. In certain embodiments, the access point traversal awareness may consist of only partial knowledge of an access point's availability for traversal. Such a case could involve whether or not a barrier to access, such as a door, is disposed so that access is completely barred. Those embodiments' controller (or equivalent thereto) can be certain that the monitored area is not accessible and hence not accessed when the barrier is closed. When/if the barrier is disposed to be not-closed, these embodiments' controller can then discern that the monitored area is not certain to be occupied nor is it certain to be unoccupied. This engendering of occupancy uncertainty can also be utilized to next engender methods and/or systems suitable for confirming occupancy such as reply-inviting queries, or action event monitoring of the monitored area (which could be left de-energized when the monitored area is known to be unoccupied and the access barrier is closed.)

Often, embodiments of the IDCSM will employ an array of detection sources, regularly including heterogeneous forms of detectors, to effect its enhanced occupancy knowledge attainment, maintenance, and exploitation. One technique recurrently incorporated into various embodiments of the IDCSM is a query-response maneuver. Once a monitored area is in a potentially occupied condition (such as when a motion has been detected within the area, but more information is not yet received) a query can be made of the potential occupants, usually following a prescribed period of time in which motion has not been detected. The query can take a wide variety of forms, including but not limited to a simple blink of the lights or an audible multiple choice question which, depending on the responses received, could presage a plurality of control events that are enactable, respectively, in reaction to a plurality of responses to the multiple choice query. A further noteworthy aspect of the IDCSM is its awareness and varied exploitation of action events that can represent the presence of actions that occur as an event within the confines of the monitored area and within the time span of interest (examples include typing on a computer, answering a phone, or manipulating an alarm clock.) In many cases, given certain states of knowledge about aspects of the occupancy of one or more monitored areas, and/or the general equivalents of a monitored area, an action event within that space can confirm, for example, that that area is then occupied. Variations of these states of knowledge can encompass both differing knowledge types including those that may be only partially comprehensive of the varieties of forms of occupancy knowledge that are at least theoretically available, as well as differing degrees of certainty and/or timeliness of the knowledge available.

Among others, notable cardinal features of the IDCSM are:
(a) Capacities to maximize the utilization of available occupancy information;
(b) Conversion of motion detection, access traversal, query response occurrences, and event incidences into occupancy related knowledge;
(c) Active and passive learning procedures, including some that are automatic while others that are potentially interactive with occupants;
(d) Composite information integration from sources that can be variously differentiated including those having differing spatial and/or temporal originations, those that are differently conditional on events and/or situational circumstances, those that are cognizant of and/or responsive to and/or providing of differing degrees of knowledge certainty, and those that are produced by heterogeneous forms of information sources; and
(e) Flexible and instructible adaptability to occupancy conditions, occupancy related events, occupancy knowledge garnering and/or exploiting objectives, occupancy knowledge responsive control actions, and occupancy related information sources.
   The panoply of the IDCSM's objectives, benefits, and capabilities variously include, but are not limited to, diverse effects such as:

1. Learning one or more monitored areas' occupancy related statuses sooner and more accurately to enable effecting energy-saving actions sooner with fewer issues from unwanted shutdowns. IDCSM timers can be set to initiate de-energization after significantly shorter motion-free periods, while avoiding unwanted blackouts by interacting with potential occupants, commonly via queries inviting occupant responses, prior to de-energizing.

2. Implementation as an augmentation to virtually any form of detector, from the most intricate to the least complicated. Some of the core IDCSM abilities include embodying automated smart control protocols that can incorporate virtually any form of sensor, from simple to complex. With only basic detector technologies, the IDCSM can still implement smarter occupant-responsive control protocols, while utilization of more capable detectors enables more intricate detection and control effects. Since the IDCSM can commonly be implemented as software, it can be adapted to work with almost any type or combinations of types of detectors used, and is even effectively future proofed, since its software is generally updatable.

3. Achievement of major efficiency and capability gains with simpler, cheaper, and more robust components. In many applications, such as a hotel or an office complex, the full benefits of an automated system are only realizable by installing and maintaining vast numbers of, among other things, detectors. Gaining greater capabilities by upgrading each individual sensor entails often significant costs amplified by their scale of application. Maintenance demands are also usually multiplied by both the substantial numbers of more complex, and hence repeatedly more trouble-prone, equipment as well as the amplified difficulty of repairing each discrete intricate detector. With the IDCSM, sizeable capability gains are readily realizable with simple, and even already installed, detectors that are cheaper and often more trouble free.

4. Integration of heterogeneous combinations of occupant detection and interaction capacities, with capability benefits that can be unfeasible when utilizing homogenous detectors. Where more complex individual detectors are necessary, they can be seamlessly integrated into an IDCSM system alongside detectors of far lesser cost, so that the greater expenses and difficulties they present are encountered only when required.

5. Adaptability to detection scenario modifications on the fly, in response to varying conditions or changes in occupant preferences, both on-site as well as remotely controlled. Software through which the IDCSM can be realized is updatable, alterable, and individually customizable to supply tailored implementations, as well as inexpensive approaches to massive operations overhauls. Additionally, the interfaces through which the adaptations can be effected are providable for users of a monitored space to effect real time IDCSM customization on-site or remotely as well, and they can even be effected via mobile devices such as a smart phone app.

6. Automatic establishment of occupancy condition knowledge persistence and immediate application of existing control protocols as well as adaptations of active protocols in accordance with changes in occupancy related knowledge. Extensions of the IDCSM can generate, maintain, and analyze records of broad varieties of occupancy related events such as detected occupant actions and patterns of collective occupancy tendencies. The IDCSM can then implement not only protocols that are responsive to ongoing events, but can be further augmented with analysis driven software modifications that can be adaptive to perceived patterns.

Differing facets and combinations of facets of the present invention's functionalities are variously incorporated in the differing embodiments of the IDCSM. These facets and the combinations thereof present representative example embodiments of the IDCSM, although it should be noted that they are by no means limiting, additional embodiment variants not specifically explicated herein also fall within the scope of the present invention. It should also be noted that the following elucidation of representative examples is illustrative, and that further representative examples that involve differing facets and their combinations, including altered numbers and/or types of combined facets and altered permutations of facet combinations. These representative examples include:

A first embodiment comprising a method of discerning and/or responding to occupancy conditions comprising the steps of: providing receivability for a first occupancy event signal associated with a first occupiable area and effecting one or more signal reactive protocols; capacitating one or more opportunities for interaction with potential occupants of the first occupiable area so that a realized interaction opportunity can engender one or more second occupancy event signals, wherein one or more of the signal reactive protocols are responsive to active signals, inactive signals, or both; and responding to at least one of the second occupancy event signals by effecting one or more of the signal reactive protocols.

Additional variants of the first embodiment can also comprise further aspects, including: (A) wherein one or more of the signal reactive protocols is reactive to one or more of the first signals, the second signals, and combinations of the first and second signals; (B) wherein one or more of the signal reactive protocols' reactivity to one or more of the first signals, the second signals, and combinations of the first and second signals is optionally modifiable; (C) wherein one or more of the first signals, the second signals, and combinations of the first and second signals can influence realizations of modifications to the protocols' signal reactivity; (D) wherein variations of the attributes of the first and/or second signals can modify the operation of one or more of the signal reactive protocols; (E) wherein the first and/or the second signals can affect one or more of the signal reactive protocols' reactivity to the first and/or second signals; (F) wherein the first and/or second occupancy event signals can influence the operativity of one or more of the signal reactive protocols; (G) wherein the first and/or second occupancy event signals can activate one or more of the signal reactive protocols; (H) further comprising the step of responding to the first occupancy event signals by engendering one or more of the signal reactive protocols; (I) wherein the first or second occupancy event signals can modify which signal reactive protocols are operationally responsive to the other occupancy event signals; and (J) wherein a first signal reactive protocol capacitates one or more interaction opportunities differently when the first occupancy event signal is active than when it is inactive.

Yet more variants of the first embodiment can comprise further aspects as well, including: (K) wherein a first signal reactive protocol, upon receiving a specific first occupancy event signal, selectively capacitates one or more specific interaction opportunities; (L) wherein, upon receiving active first occupancy event signals, a first signal reactive protocol discerns that the first occupiable area is potentially occupied and subsequently capacitates one or more interaction opportunities capable of confirming occupancy of the first occupiable area, said subsequent capacitating being optionally realizable after a period of inactive first occupancy event signals; (M) wherein a first capacitated interaction opportunity involves a query for the first occupiable area's potential occupants whose responses comprise the second occupancy event signals that can confirm occupancy of the first occupiable area; (N) wherein the receiving of the query response second occupancy event signals confirms occupancy of the first occupiable area and effects a second signal reactive protocol that maintains the occupancy confirmation when the first occupancy event signals are inactive following the query response; (O) wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals; (P) wherein a second interaction opportunity involves capacitating receipt of second occupancy event signals engendered by one or more detectors of traversal of one or more portals associated with the first occupiable area; (Q) wherein, when occupancy of the first occupiable area is confirmed, the occupancy's confirmation is maintained while the second occupancy event signals associated with the first occupiable area portal traversal detectors are inactive; (R) wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals; (S) further comprising controlling one or more output signals with one or more of the signal reactive protocols; and (T) further comprising the step of collecting information related to one or more of the interaction opportunities, occupancy event signals' active and/or inactive occurrences, occupancy events, occupiable areas associated with occupancy event signals, signal reactive protocols, and responses to the signals.

A second embodiment comprising a system for discerning and/or responding to occupancy conditions comprising: a controller capable of both receiving a first occupancy event signal associated with a first occupiable area and effecting one or more signal reactive protocols that are responsive to active signals, inactive signals, or both; wherein the controller can further (A) capacitate one or more opportunities for interaction with potential occupants of the first occupiable area so that a realized interaction opportunity can engender one or more second occupancy event signals, and (B) respond to at least one of the second occupancy event signals by effecting one or more of the signal reactive protocols.

Additional variants of the second embodiment can also comprise further aspects, including: (A) wherein one or more of the signal reactive protocols is reactive to one or more of the first signals, the second signals, and combinations of the first and second signals; (B) wherein one or more of the signal reactive protocols' reactivity to one or more of the first signals, the second signals, and combinations of the first and second signals is optionally modifiable; (C) wherein one or more of the first signals, the second signals, and combinations of the first and second signals can influence realizations of modifications to the protocols' signal reactivity; (D) wherein variations of the attributes of the first and/or second signals can modify the operation of one or more of the signal reactive protocols; (E) wherein the first and/or the second signals can affect one or more of the signal reactive protocols' reactivity to the first and/or second signals; (F) wherein the first and/or second occupancy event signals can influence the operativity of one or more of the signal reactive protocols; (G) wherein the first and/or second occupancy event signals can activate one or more of the signal reactive protocols; (H) wherein the controller responds to the first occupancy event signals by engendering one or more of the signal reactive protocols; (I) wherein the first or second occupancy event signals can modify which signal reactive protocols are operationally responsive to the other occupancy event signals; (J) wherein a first signal reactive protocol capacitates one or more interaction opportunities differently when the first occupancy event signal is active than when it is inactive; (K) wherein a first signal reactive protocol, upon receiving a specific first occupancy event signal, selectively capacitates one or more specific interaction opportunities; (L), wherein upon receiving active first occupancy event signals, a first signal reactive protocol discerns that the first occupiable area is potentially occupied and subsequently capacitates one or more interaction opportunities capable of confirming occupancy of the first occupiable area, said subsequent capacitating being optionally realizable after a period of inactive first occupancy event signals.

Yet more variants of the second embodiment can comprise further aspects as well, including: (M) wherein a first capacitated interaction opportunity involves a query for the first occupiable area's potential occupants whose responses comprise the second occupancy event signals that can confirm occupancy of the first occupiable area; (N) wherein the receiving of the query response second occupancy event signals confirms occupancy of the first occupiable area and effects a second signal reactive protocol that maintains the occupancy confirmation when the first occupancy event signals are inactive following the query response; (O) wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals; (P) wherein a second interaction opportunity involves capacitating receipt of second occupancy event signals engendered by one or more detectors of traversal of one or more portals associated with the first occupiable area; (Q) when occupancy of the first occupiable area is confirmed, the occupancy's confirmation is maintained while the second occupancy event signals associated with the first occupiable area portal traversal detectors are inactive; (R) wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals; (S) wherein one or more output signals is controlled with one or more of the signal reactive protocols; and (T) wherein information related to one or more of the interaction opportunities, occupancy event signals' active and/or inactive occurrences, occupancy events, occupiable areas associated with occupancy event signals, signal reactive protocols, and responses to the signals is collected.

A third embodiment comprising computer-readable media having computer-useable instructions embodied thereon to perform a method of assessing events associated with usage of a monitored space, said method comprising: instituting one or more assessment procedures responsive to precursor evidence of usage of one or more monitored spaces by being receptive to successor evidence of usage of at least one of the monitored spaces, said successor evidence comprising data capable of indicating either usage detected or usage undetected, said receptivity optionally occurring after a specifiable period; receiving the data comprising the successor evidence; and responding with one or more of the assessment procedures by assessing, from the data indicating either usage detected or undetected, events potentially associated with usage of monitored space.

Additional variants of the third embodiment can also comprise further aspects, including: (A) when a first monitored space has evinced usage, said responding step further comprises (1) engendering a usage related interaction that establishes present usage occurrence, and (2) maintaining the assessment of present usage occurring until the successor evidence indicates one or both of: (i) usage detected data; and (ii) an interruption of usage not detected data continuity; (B) wherein, when a first monitored space has evinced usage, said responding step further comprises engendering a usage related interaction that can establish present usage occurrence; (C) wherein the successor evidence includes motion detection within the monitored space so that the assessment that usage is presently occurring is maintainable without need for further evidence until motion detection evidence reoccurs; (D) following precursor usage evidence, said responding step includes engendering an interaction involving a reply-inviting query for the usage source, such that a reply confirms present usage; (E) when present usage occurrence has been established, said responding step includes monitoring access to the monitored space, wherein continuing usage is confirmed until either or both of (1) data indicating traversal of one or more accesses is received, and (2) data indicating no traversal is not continuously received; (F) when sufficiently many producers of the precursor and successor evidence are available, wherein only selected partial portions of the available producers of the precursor and successor evidence can be activated, and/or the monitored space can be differentially demarcated so that the assessment procedures instituted and/or the assessing effected can assess events associated with selected subdivisions of the monitored space; (G) wherein the selecting of the partial portions of the evidence producers and/or the selecting of the subdivisions of the monitored space is effectible with a user interface, said interface being optionally configurable as a graphical user interface; and (H)—an additional sub-variant of the third embodiment (D) variant—wherein (1) a first and a potential second sound sensor signal are respectively producible by spatially separated first and second sound sensors in response to a first sound event occurring in the monitored space, said first and second sound sensor signals' difference exceeding a first threshold only when the first sound event's source is within the monitored space, and (b) the first sound event qualifies as a query reply when it is a timely sound sourced from within the monitored space; and further comprising the step of discerning, upon receiving a first sound sensor signal, whether a potential second sound sensor signal that differs from the first signal by more than the first threshold is received.

A fourth embodiment comprising a grouping of one or more computer executables that assess events associated with usage of a monitored space comprising at least one each of: an executable procedure responder to precursor evidence of usage of one or more monitored spaces by becoming receptive to successor evidence of usage of at least one of the monitored spaces, said successor evidence comprising data indicating usage either detected or undetected, said receptivity optionally occurring after a specifiable period; and an executable procedure assessor that receives the successor evidence and assesses, from the precursor and successor evidence, the potential of events associated with usage of the monitored space.

Additional variants of the fourth embodiment can also comprise further aspects, including: (A) wherein, when current usage is established, the responder continues the assessment that usage is current until the successor evidence evinces one or both of: (1) usage detected data; and (2) an interruption of usage not detected data continuity; (B) wherein, following receipt of the precursor usage evidence, the responder engenders an interaction able to establish current usage; (C) wherein, following receipt of the precursor usage evidence, the responder engenders an interaction involving a reply-inviting query for the usage source, such that a reply confirms current usage; (D)—an additional sub-variant of the preceding fourth embodiment (C) variant—wherein (1) the successor evidence comprises a first and a potential second sound sensor signal respectively producible by spatially separated first and second sound sensors in response to a first sound event occurring in the monitored space, said first and second sound sensor signals' difference exceeding a first threshold only when the first sound event's source is within the monitored space, and (2) the first sound event qualifies as a query reply when it is a timely sound sourced from within the monitored space; and said assessor, upon receiving the first sound sensor signal, discerns whether the potential second sound sensor signal that differs from the first signal by more than the first threshold is received; (E) following establishment of current usage, wherein the assessor monitors access to the monitored space and confirms continuing current usage until either or both of (1) access occurs, and (2) an interruption of access continuously not occurring; (F) wherein the usage evidence is produced by one or more forms of occupancy detector, said detector forms including motion detector alternate options; and (G) when current usage has been confirmed and then usage evidence from a detector of motion in the monitored space is subsequently received, the assessor then assesses that the usage of the monitored space is potential, but no longer confirmed.

a fifth embodiment comprising a method of assessing events associated with an observed area comprising the steps of: observing a first area sufficiently that occurrences of access to and/or from the first area are observed; perceiving a first action event occurring in the first area and then effecting a first determination that a first action event source is in the first area when the first action event occurred; and, optionally, maintaining the first determination that the first action event source is in the first area until a first observation of the first area access occurrence.

Additional variants of the fifth embodiment can also comprise further aspects, including: (A) further comprising, in response to the first observation, a step of effecting one or more device control protocols, said protocols generally including options for controlling first area devices; (B) further comprising a step of exchanging the first determination for a second determination, upon occurrence of the first observation, wherein the second determination is that the first action event source is potentially in the first area; (C) further comprising, when the exchange for the second determination has been effected and the first action event source is a potential occupant of the observed area, a step of capacitating one or more interactions with the first action event source, wherein optional variants for a first interaction include engendering one or more answerable queries for the potential occupant and one or more answers to the queries can inform regarding one or more of (1) the occupant's presence within the first area; (2) the occupant's intended manner of occupation of the first area; and (3) the occupant's preferred device control protocols to be effected in response to the assessed events; (D)—an additional sub-variant of the fifth embodiment (C) variant—wherein the query is answerable with a timely sound event sourced from within the observed area, further comprising the steps of: (1) capacitating receptivity to a first and a potential second sound sensor signal that are respectively producible by spatially separated first and second sound sensors in response to a first sound event occurring in the observed area, said first and second sound sensor signals' difference exceeding a first threshold only when the first sound event's source is within the observed area; and (2) discerning, upon receiving the first sound sensor signal, whether the potential second signal that differs from the first by more than the first threshold is received (E) wherein the query can assume a variety of modes including audible sounds and visible device control affects such as blinking lights; (F) wherein the occupant's query answer can assume a variety of modes including audible sounds such as speech, and action events such as effecting a detectable movement; and (G) wherein the occupant's query answer can involve options of producing one or more specifically differentiated sounds including one or more distinct control sounds which can convey correspondingly distinct answers.

A sixth embodiment comprising a method of assessing events associated with an observed area comprising the steps of: observing a first area sufficiently that occurrences of access to and/or from the first area are observed, and realizing a first observation that an initial first area access has occurred; capacitating one or more opportunities for interaction, upon the realizing of the first observation, wherein realizing an interaction entails engendering a first action event in the first area; effecting a first determination that one or more occupants are in the first area when the first action event occurred; and, optionally, maintaining the first determination that occupants are in the first area until a second observation of first area access. Additional variants of the sixth embodiment can also comprise further aspects, including (A) wherein optional variants for a first interaction opportunity include engendering one or more answerable queries for potential first area occupants so that one or more answers to the queries can inform regarding one or more of (1) the potential occupant's presence within the first area; (2) the potential occupant's intended manner of occupation of the first area; and (3) the potential occupant's preferred device control protocols to be effected in response to the assessed events; and (B)—an additional sub-variant of the sixth embodiment (A) variant—wherein the query is answerable with a timely sound event sourced from within the observed area, further comprising the steps of: (1) capacitating receptivity to a first and a potential second sound sensor signal that are respectively producible by spatially separated first and second sound sensors in response to a first sound event occurring in the observed area, said first and second sound sensor signals' difference exceeding a first threshold only when the first sound event's source is within the observed area; and (2) discerning, upon receiving the first sound sensor signal, whether the potential second signal that differs from the first by more than the first threshold is received.

A seventh embodiment comprising a controller suitable for attaining occupancy awareness utilizable for device control comprising: processor-executable programming able to effect a multitude of controller states in response to received signals of events related to occupancy of a monitored space, including a first state corresponding to a subject being potentially within the monitored space, a second state corresponding to effecting opportunities for the subject to confirm presence in the monitored space, a third state corresponding to confirmation of the subject's presence in the monitored space; and, optionally, an initial state in which the controller is not aware of occupancy of the monitored space; wherein particular signal generating occupancy related events are requisite for the subject's presence in the monitored space to be altered so that when the controller is in the third state it maintains awareness of the subject's confirmed presence in the monitored space without further presence awareness attaining actions until receipt of the particular signals.

Additional variants of the seventh embodiment can also comprise further aspects, including: (A) wherein the programming can variously instruct the controller to output control signals including energization and de-energization signals when the controller assumes one or more of the first, second, third, and optionally, initial states; (B) wherein a first particular signal generating occupancy related event is a motion detection; (C) wherein a second particular signal generating occupancy related event is a detection of potential traversal of one or more monitored space portals; (D) wherein a first effected opportunity for presence confirmation when the controller is in the second state involves the controller effecting a query challenge and being receptive to query responses from the subject such that the controller effects the third state upon receipt of an appropriate subject response to the query challenge; (E)—an additional sub-variant of the seventh embodiment (D) variant—when a first appropriate subject response entails a timely sound event sourced from within the monitored space and the second controller state is in effect, the processor-executable programming further effects: (1) capacitating receptivity to a first and a potential second sound sensor signal that are respectively producible by spatially separated first and second sound sensors in response to a first sound event occurring in the monitored space, said first and second sound sensor signals' difference exceeding a first threshold only when the first sound event's source is within the first monitored area; and (2) discerning, upon receiving the first sound sensor signal, whether the potential second signal that differs from the first by more than the first threshold is received; (F) wherein, when in the initial state, the controller effects the first state in response to receipt of signals of events related to occupancy of the monitored space; (G) wherein a first effected opportunity for presence confirmation when the controller is in the second state involves the controller effecting a query challenge, said query challenge optionally occurring after the controller has effected the first state for a specifiable period, and being receptive to query responses from the subject such that the controller effects the initial state when an appropriate subject presence confirming query response signal is not received.

An eighth embodiment comprising a system for distinguishing sound events' occupancy implications comprising: a signal comparator, a first sound sensor respondable to a first sound event detectable in a first monitored region and a second sound sensor separated from the first sound sensor; wherein differences in the responses of the first and second sound sensors to the first sound event are determinable by the signal comparator to exceed a first threshold only when the first sound event's source occurs within the first sub-region. Additional variants of the eighth embodiment can also comprise further aspects, including: (A) wherein the first threshold is selected so that the assessor can discern that the first sound event source is not within the first monitored area when the received second sound sensor signal does not differ from the first sound sensor signal by more than the first threshold; (B) wherein, when the assessor is treating timely sound as a potential control sound response to a query of a potential occupant of the first monitored area, the assessor can avoid treating the first sound event as being sourced by the potential occupant of the first monitored area when the received second sound sensor signal does not differ from the first sound sensor signal by more than the first threshold; and (C) wherein the first sound event is timely when it occurs within a selected period of time following the query.

A ninth embodiment comprising a method of assessing sound events' occupancy implications comprising the steps of: capacitating receptivity to a first and a potential second sound sensor signal that are respectively producible by spatially separated first and second sound sensors in response to a first sound event occurring in a first monitored area, said first and second sound sensor signals' difference exceeding a first threshold only when the first sound event's source is within the first monitored area; and discerning, upon receiving the first sound sensor signal, whether the potential second signal that differs from the first by more than the first threshold is received. Additional variants of the ninth embodiment can also comprise further aspects, including: (A) wherein the first threshold is selected so that said discerning also recognizes that the first sound event source is not within the first monitored area when the received second sound sensor signal does not differ from the first sound sensor signal by more than the first threshold; (B) wherein, when timely sound is treated as a potential control sound response to a query of a potential occupant of the first monitored area and the received second sound sensor signal does not differ from the first sound sensor signal by more than the first threshold, the first sound event is treated as being not sourced by the potential occupant of the first monitored area; and (C) wherein the first sound event is timely when it occurs within a selected period of time following the query.

A tenth embodiment comprising a system for assessing events associated with an observed area comprising: (1) a first area observer that observes any access to and/or from the first area and realizes a first observation when a first area access occurs; (2) an interactor, optionally capacitated by realization of the first observation, that can realize an interaction when a first action event occurs in the first area; and (3) an assessor that can, (a) effect a first determination of use of the first area when the first action event occurs, and optionally, (b) maintain the first determination until a subsequent first observation. Variants of the tenth embodiment can also comprise further aspects, including, when at least partial mitigation of a barrier to first area access suffices to realize the first observation and the first action event can include motion detection, wherein the step of maintaining the first determination is definite. Other objects and features will be in part apparent and in part pointed out hereinafter.

### BRIEF DESCRIPTION OF THE DRAWINGS

FIG. 1 is a schematic illustration showing relationships and interaction channels of the controller and other aspects of some embodiments of the present invention.

FIG. 2 is a representative illustration showing how certain embodiments of the present invention can utilize selected constituent components arranged about an exemplary residential floor plan.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures.

Terms utilized in the present application (distinguished by capitalization in the table below) are to be interpreted in accordance with all of the variety of definitions and meanings encompassed by the multitude of definitions available in the full variety of publicly accessible dictionaries, except where specifically directed against in the specification and claims of the present application. In the following table, the additional meaning related notes presented are intended to further elucidate certain implications and or ranges of applicable meanings in the context of the present invention's functions and purposes.

| | |
|---|---|
| 1) | Occupiable Area- Can also include an area (i.e. space, region, volume, room, structure, |
| | etc.) capable of being occupied by one or more animate or inanimate occupants. |
| 2) | Occupancy Conditions- Can also include any and/or all of the characteristics, attributes, |
| | features, circumstances and/or situations that are at least potentially related or associated |
| | with one or more occupancies of interest. |
| 3) | Occupancy Event Signal- Can also include a signal, such as a data transmission, that |
| | indicates an event, usually an occurrence of one or more events, at least potentially |
| | related or associated with one or more occupancies of interest. |
| 4) | Signal Reactive Protocols- Are protocols that are capable of acting in response, in addition |
| | to the other meanings of being reactive including, for example, capable of enacting a lack |
| | of responsive action when a received signal is not intended to engender a response action |
| | according to the signal reactive protocol then in effect. |
| 5) | Capacitating- Can also include engendering the capacity of interest. |
| 6) | Opportunities For Interaction- Interactions of interest can additionally present significant |
| | information both when occurring, and when their occurrence is specifically not occurring. |
| | Hence, it is of significance when a situation has been engendered wherein an opportunity |
| | for an interaction has been engendered, said opportunity being capable of comprising any |
| | specific or general enactment or capacitation of a potential interaction. |
| 7) | Potential Occupants- Can additionally refer to those that actually do occupy an area, those |
| | that might, those that could only in theory, and those that are of uncertain existence or |
| | location. |
| 8) | Operativity- The capacity to operate. |
| 9) | Activate- Engendering that the subject item is rendered active. |
| 10) | Inactive- In addition to the normal meanings, in certain contexts of the claims of the present |
| | application, particularly when referring to signals it is recurrently discussed within the |
| | present application that when a motion detector is not registering a motion, it is actually |
| | registering a detection of an absence of motion. A signal which can be active to transmit |
| | the data representative of a motion detection may also be configured to be entirely absent, |
| | i.e. an inactive signal, when there is not a motion detection. In the context of certain |
| | embodiments of the present invention, however, the existence of an inactive signal can be |
| | recognized as equivalent to a detection of an absence of motion so that the system is able |
| | to utilize an inactive signal as being equally meaningful but not necessarily equivalent in |
| | meaning. Hence whether a signal is actively presenting information or not actively |
| | presenting information, embodiments of the present invention are capable of utilizing |
| | both as similarly meaningful, and hence both are termed signals, with the absence of an |
| | otherwise potentially present signal also serving essentially comparably to an active |
| | signal. |
| 11) | Usage- Among the potential applications of various embodiments of the present invention |
| | are those that could even include inanimate objects that occupy various spatial |
| | subdivisions such as storage bins in a warehouse. In such a case, as well as in the more |
| | conventional cases wherein an animate subject, such as a human, is the occupant, the |
| | term usage is applicable well in both and other situations, and is generally at least as |
| | broad as the term occupy, although usually it would be considered far more general. |
| 12) | Usage Related Interaction- Can also include almost any form of action by the occupant that |
| | can include interacting with at least some portion of the monitored area and/or its |
| | associated detectors and/or its associated equipment. |
| 13) | Data Continuity- Meanings can also include a characterization of the degree and/or |
| | presence of the continuity of the data received. |
| 14) | Reply-Inviting Query- Can also include the interpretation in which the query of interest is |
| | implicitly presenting an invitation for a reply to the query. For example, engendering an |
| | opportunity for an interaction can entail enacting a query which invites a reply. |
| 15) | Preferred Device Control Protocols- Can also include the interpretation in which the |
| | exercising of a preference, including by one or more occupants, can be enacted with one |
| | or more of the device control protocols. The device controls include essentially any |
| | action or step or result in which the present invention is involved in firstly, |
| | intermediately, or finally to produce an output that does or can effect the device. |
| 16) | Access- Meanings can also include, in the present context, both a physical article (i.e. a |
| | doorway) as well as a virtually defined article (i.e. a border of an open space can be |
| | defined by fiat, though not even physically realized, and the points of access can be |
| | sufficiently monitored such that it can also be treated as a closed monitored space) as |
| | well as the verb and the noun meanings of the term. |
| 17) | Action Event- Can also include essentially any occurrence which can indicate or be |
| | associated with an action by a potential occupant. |
| 18) | Intended Manner Of Occupation- In certain circumstances, embodiments of the present |
| | invention can operate differently in response to intended patterns of use and/or |
| | occupation of an area of interest, for example, a signal reactive protocol could enact |
| | different reactive procedures when the occupant intends to read a book in bed versus go |
| | to sleep for the night. |
| 19) | Control Sounds- Can also include any sound that is specifically created, sought out by a |
| | recognizing audio monitor, or produced with the intention of being effective in |
| | influencing a controlling action or inaction. |
| 20) | Control Sounds- Can also include any sound that is specifically created, sought out by a |
| | recognizing audio monitor, or produced with the intention of being effective in |
| | influencing a controlling action or inaction. |
| 21) | Sound Event- Refers largely to the existence of a sound at a place and time, i.e. an event |
| | consisting of the existence of detectable sound. |
| 22) | Sound Event- Refers largely to the existence of a sound at a place and time, i.e. an event |
| | consisting of the existence of detectable sound. |

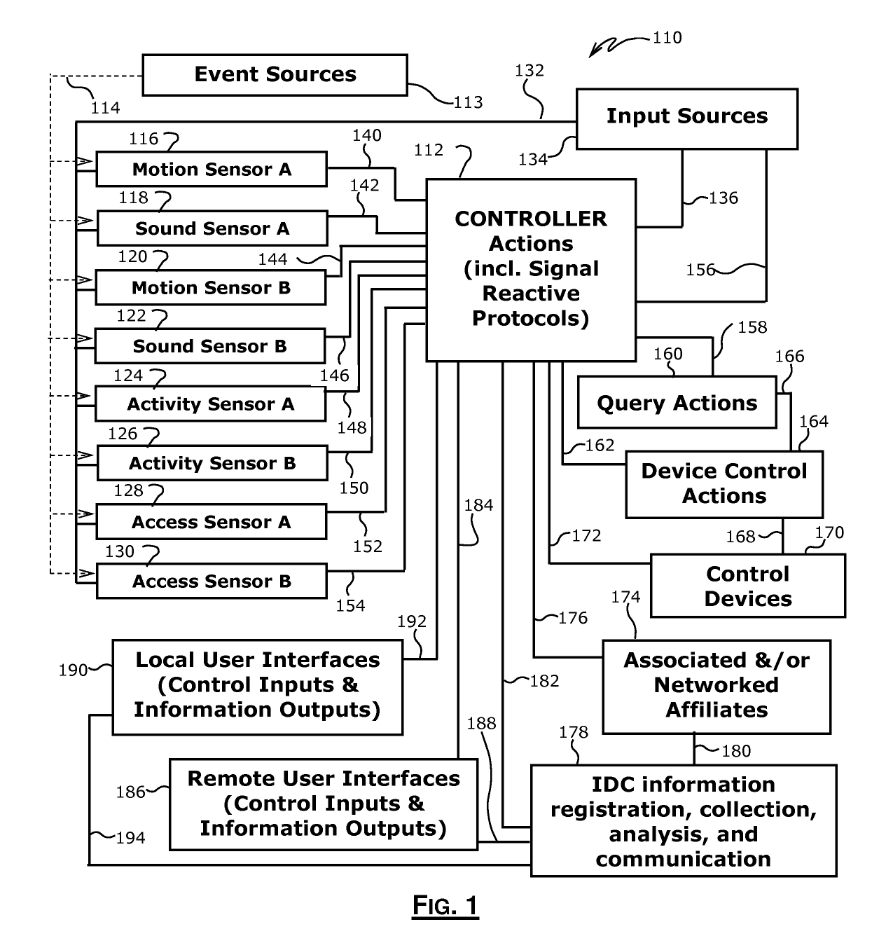

Many of the constitutive aspects and the functional facets, as well as their roughly characterized operative relationships, of various embodiments of the present invention are depicted schematically in FIG. 1 which is configured to schematically illustrate these embodiments' representative operational narratives. An assemblage 110 of functional facets comprises ranges of potential components present in many of the embodiments of the IDCSM, though several embodiments of the IDCSM may comprise only a portion of the potential constituents depicted in FIG. 1. The relationships and/or communications, often also referred to as channels, are generally considered to be 2-way channels, unless otherwise directed. It is also important to note that the constituents and relationships depicted in FIG. 1 symbolize features and operations of either or both the methods and systems of many embodiments of the present invention, wherein in many cases the functional components described can alternatively refer to a constituent (and/or its operations) of a system embodiment, as well as an operative aspect (and/or its constitutive components) of a method embodiment. For brevity of description these operations, constituents, relationships, and/or components of the embodiments of the systems and methods of the present invention will be collectively referred to as functional facets. Primarily present in most embodiments is the chief receiver and/or effector 110 of the functions of the present invention, referred variously to as: (a) signal reactive protocols; (b) controller; (c) assessment procedures; (d) computer executable procedures; (e) event assessing; (f) processor-executable programming; (g) signal comparators; (h) signal assessor; (j) sound event assessing; and (k) IDCSM actions (for brevity of communication referred to collectively hereafter, unless otherwise indicated, as the controller 112.) It is also important to note, that as described earlier n the parent applications of the present application, that the controller 112 can exist as a distinct and continuing device or software implementation, as well as exist as a virtual controller 112, that can be temporary or reconfigurable as well as enduring, and that the term controller 112 can refer to any of these controller 112 iterations, unless otherwise specified herein. The systems and methods of the present invention are often concerned with assessing, interacting, and observing, among other features, events and potential events that are ultimately engendered by event sources 113, which can include occupants, devices, usage conditions, and a number of other event origins. Manifestations of events are potentially sensed via event source interactions 114 with one or more of various interfaces which can include a motion sensor A 116, a sound sensor A (such as a microphone) 118, a motion sensor B 120, a sound sensor B 122, an activity sensor A 124, an activity sensor B 126, an access sensor A 128, and an access sensor B 130.

In general, the range of meanings of the characterizing labels for the sensors 116-130 are to be interpreted as broadly as the language allows, so that a motion sensor can comprise, but not be limited to, infrared motion sensors (please refer to the additional alternative sensor types delineated in the parent applications in addition to those well known to those of skill in the art including, for example, ultrasonic, dual detection mode approaches such as combinations of microwave and passive infrared, and video cameras combined with intelligent monitoring) as well as any other manner of motion sensing. Similarly, the sound sensors can comprise any manner of sound sensing, the activity sensors can comprise any manner of activity sensing, and the access sensors can comprise any manner of sensing of accessing. It should also be noted that, while the many of the applications and operations of many of the embodiments of the present invention are specifically intended to be interactive with potential human occupants of a space or area, there are also utilities affordable of at least some of the embodiments of the present invention that are also relevant to occupancy related issues for non-human beings (house pets, for example) and even for non-animate entities (such as stored items in a warehouse.) Depending on the range of intended applications, differing embodiments of the present invention would incorporate differing capabilities and/or manners of interaction with the occupants (animate or inanimate.) In the example of the house pets, a reply inviting query would have to be appropriately designed so as to elicit an identifiable response, which may or may not be always feasible for the house pet being interacted with. For example, designing a system in which a dog would reliable respond with an appropriate response, i.e. barking, to a query would likely be easier, and more certain, than if the pet were a turtle. Such specializations are well known in various quarters, but delineating those specialized details is not the critical focus of the present application. Similarly, there would often be certain adaptations necessary for selected embodiments to enable their utilization with inanimate objects such as monitoring accessing of bins in a warehouse, which would of course include very little utilization of reply inviting queries.

The sensors' 116-130 (when present) providing of inputs for the controller 112 are collectively characterizable as input sources 134, which operatively relates with the controller's receiving capacities 136. The controller 112 may also provide operative feedback, sensor control and/or selection functions, in addition to instituting variations in its manner or degree of relationship with the various sensors 116-130, via the schematic channels 140-154, respectively. The controller 112 may also provide such forms of interaction with the input sensors collectively, for example as an overall strategy for all operative sensors in one case or as a general deactivation of all sound sensors in a second case, via schematic channel 156. In addition to the controller 112's relationships with the sensors 116-130, whose functions are commonly characterizable as simply reactive receptiveness, the controller 112 may also engender more active operative capacities beyond the sensors' 116-130 operations including, via schematic channel 158, instituting and/or interacting with query actions 160. The controller 112 may also engender, via schematic channel 162, various device control actions 164. The device control actions 164 can also be interactive, via schematic channel 166, with the query actions 160. A schematic channel 168 provides interactivity between the device control actions 164 and various control devices 170 including devices, and their virtual counterparts, that can effect actions such as shining a light in response to instructions from the controller 112. The control devices 170 also are interactive with the controller 112 via schematic channel 172. A wide ranging assortment of further capabilities and/or interactions are also potentially interactive with the controller 112, including (a) associated and/or networked affiliates 174 (interactive with the controller 112 via schematic channel 176); (b) a variety of intelligent device control (IDC) related information registration, collection, analysis, and communications functional facets 178 (potentially interactive with one or both of the associated and/or networked affiliates 174 and the controller 112 via schematic channels 180 and 182, respectively.)

The controller 112 can also be interactive, via channel 184, with one or more remote user interfaces 186 such as an Internet connected control panel for managing the occupancy detection scenarios of either a collection of disbursed facilities administered jointly by a central office or of a range of differing installations in a multi-story tower monitored from a ground floor situated controller. These interfaces would, for example, send control inputs and/or receive informational outputs to and from their channels 186, and/or 188. One or more local user interfaces 190 can provide relatively close proximity capacities similar to those available from the remote user interfaces 186, as well as interactivity with the controller 112 via channel 192, and with the IDCSM information facets 178 via channel 194. The local user interfaces are also capable of providing more direct and/or more complex manners of interactivity and/or local management of the functional facets of individual embodiments of the present invention. A representative illustration of the additional local control capacities includes enabling an occupant to tailor the functions of the controller (and hence the controller related devices as well) on-the-fly, so to speak, wherein differing signal reactive protocols for occupancy detection and device control procedures can be modified instantly to accommodate the moment-by-moment alterations in the occupant's intended mode of occupancy, for example whether the occupant planned on going to sleep (in which case they would not want any more reply inviting audible queries to occur) or planned on reading in bed (in which case they would not want any light-blinking queries to occur even though they would possible be motionless enough to trigger an occupancy uncertainty that would lead to a query in some scenarios.)

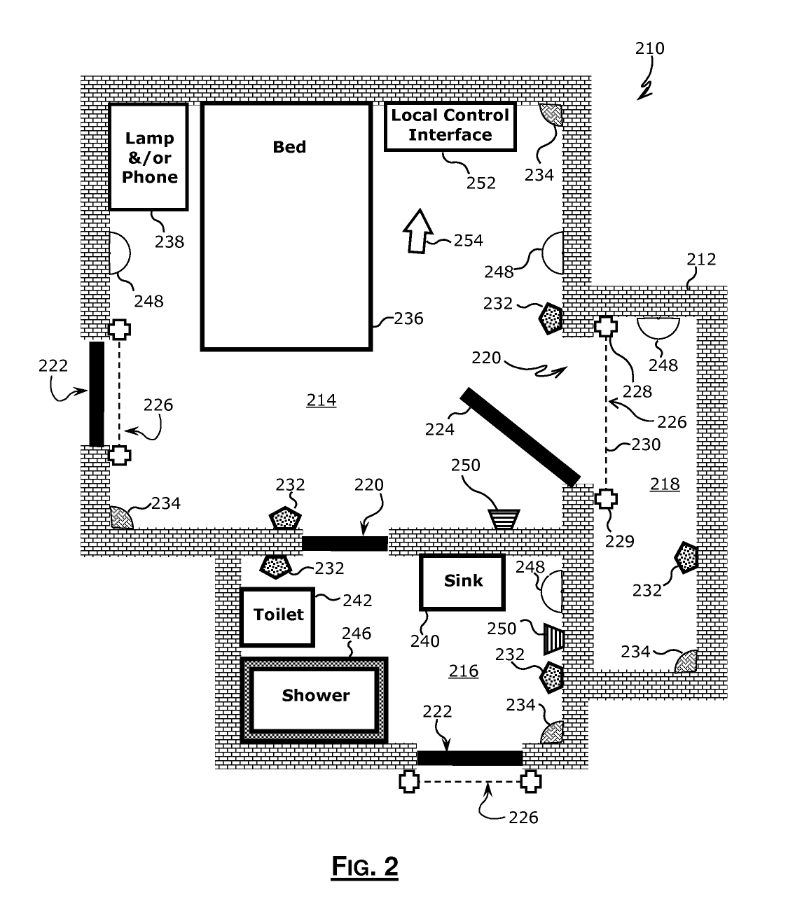

FIG. 2 schematically illustrates a first arrangement of several aspects of, and is also instructive of various operative scenarios effectible by some of the embodiments of the present invention. (Please note that the controller 112, FIG. 1 shown channels that link the controller 112 with various aspects of the present embodiment, and related aspects of implementations of some embodiments of the present invention are not shown for purposes of clarity of representation, much as one can have a telephone linkage available in a room that is primarily hidden from view.) A common multi-room floor plan 210 shows a layout of walls 212 that demarcate interior spaces including a bedroom 214, a bathroom 216 and a closet 218. Interior portals 220 provide access between the bedroom 214 and the bathroom 216 or the closet 218. Exterior portals 222 provide egress/ingress access to the bedroom and the bathroom. The portals 220 and 222 typically include a door 224 that is shown, for the bedroom/closet portal 220, in an opened disposition thereby allowing access to and from the closet 218. Optionally providable access detectors 226, disposable at the portals 220 and/or 222, are configurable in a variety of manners well known to those of skill in the art, including the passageway traversal sensor described in the present application's parent application Ser. No. 12/144,154 (now U.S. Pat. No. 7,765,033). In correspondence to the parent application passageway traversal sensor, the access detector 226 can include a light source 228, a light receiver 229, and light beam 230 sent from the light source 228 to the light receiver 229, which can then indicate that the portal traversal due to access occurrence when receipt of the light beam 230 by the light receiver 229 has been interrupted. The floor plan 210 includes a representative assembly of components that can be utilized to implement various embodiments of the present invention, but it should not be interpreted as limiting in any way of the number, types, dispositions, or purposes of the functional facets that can be incorporated in differing embodiments of the present invention. Among these potential functional facets are motion sensors 232; sound sensors 234; activity sensors (not shown) that can be tied into various apparatuses such as a bed 236, a lamp and/or phone 238, a sink 240, a toilet 242, and a shower 246 that are at least partially containable within the floor plan 210; lights 248; speakers 250, and a local control interface 252. An arrow tip 254 indicates a specific room location (generally randomly selected from among a range of possibilities, though also positioned to enable elucidating description of some of the operations of some of the embodiments of the present invention) which is of use in describing scenarios of some embodiments of the present invention.

A wide ranging mixture of differing operational interactions are encompassed by the functional facets of the embodiments of the present invention, and it should be understood that while a number of these operational interactions are explicated herein and in the parent applications of the present application, that additional embodiments also fall within the scope of the present invention. Examples of these further embodiments and their variations, in addition to those more copiously detailed herein, are easily comprehended by recognizing that combinations of aspects and functional facets from one embodiment are combinable with functional facets of one or more other embodiments, and that the various embodiments' combinations and scenarios can also be reconfigured by varying the functional facets' numbers, relationships, operative procedures, and permutations both within individual and within combinations of embodiments.

Considerations of some of the significant operative relationships of the functional facets of FIGS. 1 & 2 can be generally instructive regarding, but not limiting of, routinely effected operational narratives of some of the representative examples of the present invention. In various permutations (including those that incorporate differing numbers, not excluding complete absence, of virtually any component) each of these operational narratives, and their variants, can describe a variety of realizations of embodiments of the present invention. The completely incorporated herein disclosures of the three parent applications of the present application: (1^{st}) U.S. Provisional Application Ser. No. 60/945,797, filed Jun. 22, 2007; (2^{nd}) U.S. Non-Provisional application Ser. No. 12/144,154, filed Jun. 23, 2008 (now U.S. Pat. No. 7,765,033); and (3^{rd}) pending U.S. Non-Provisional application Ser. No. 12/844,617 filed on Jul. 27, 2010 provide substantial detailed exposition describing various operations that are also applicable, and are explicitly incorporated by reference herein, to understanding the full range of the embodiments of the present invention. In particular, the above clarification regarding the various permutations of the present invention's operational narratives applies distinctly to the parent applications' descriptions, and especially to how they can be deconstructed to illustrate more directly the ranges of the embodiments of the present invention. The subsequent express emphasis on exemplary core capabilities of selected embodiments of the present invention elucidates the extent of the present invention's scope, both for separate embodiments and through a recognition of the separate embodiments' inherent capacities for intermingling and/or merging their operational capabilities.

A first representative scenario entails a monitored space and the associated deployment of the controller 112; the motion sensors A & B, 116 and 120, respectively (such as motion sensors 232); and the sound sensors A & B, 118 and 122, respectively (such as sound sensors 234). Whatever channels required to appropriately interconnect these functional facets are also included in the present first scenario, though not described in more detail at present since there is essentially an unlimited number of ways to physically realize these channels as is well known to those of even less than ordinary skill in the art, and for purposes of understanding the present narrative it is sufficient to just define that such channels exist in principle, wherever required. Postulate that a movement by a person within the monitored space (or region, room, area, storage bin, etc.) is detected by the motion sensor A 116, which indicates the potential for the monitored space to be occupied (though not the certainty since an individual could merely be passing through the monitored space.) The controller can then implement a first signal reactive protocol in which, after a proscribed period of time (the duration of which can be fixed or adjustable locally, remotely, in response to pre-determined factors, and/or in response to other operations of the controller 112, among other ways) engenders a reply-inviting query action 160 of a potential occupant of the monitored space. Commonly, the reply inviting query action 160 can utilize any of, individually or in combination, the lamp or phone 238 (by, for example, the phone emitting a specific unique tone or the lamp dimming), the local control interface 252 (by, for example, displaying a visual message), the lights 248 (by, for example, blinking in a set pattern), and/or the speakers 259 (by, for example, playing a sound recording) to inform the potential occupant that an action, such as turning off the room lights 248, is imminent. The controller 112 may then implement a first signal reactive protocol in which it waits to register an appropriate reply from the occupant, if present, indicating, for example, that the occupant is present and does not want the lights turned off. Such a reply can assume a multitude of forms, with the suitable adjustments, including but not limited to forms that involve motion, sound, and activity. In the case of a sound based reply, such as an occupant speaking, the controller 112 can be informed that the space is definitely occupied by the spoken reply. Then, by continuously monitoring the motion sensors A & B, 116 and 120, respectively, following the confirming reply, the controller 112 can be “certain” that the occupant remains in the space until at least one of the motion sensors A & B, 116 and 120, respectively, detect motion again, in which case the controller 112 will then assess that continued occupancy of the room is possible, but not confirmed.

Using multiple motion detectors can enable, with suitable adaptations, for one to detect only motion occurring within a sub-space (for example, the bedroom 214 or the bathroom 216) of the monitored space when a divider such as the portal 220 divides the monitored space (e.g. the floor plan 210.) This can enable the controller 112 to customize its control of the lights 248 so that when the occupant does not confirm presence in the bathroom 216 the lights 248 in the bathroom 216 can be turned off while the lights in the bedroom 214 may be left on. A room such as the closet 218 may only require a limited amount of the sensors 116-130 since it has no external exit. Similarly when it is confirmed that the floor plan 210 has no occupants, the controller 112 may need to initially recognize signals only from the bathroom 216 or the bedroom 214 access detectors 226 since any occupancy of the floor plan 210 must begin with traversal of at least one of those two access detectors 226 (and cannot begin with traversal of the closet 218 motion detector 226 which can then be turned on once the floor plan 210 is again potentially occupied.) When occupancy of the floor plan 210 has been confirmed, adjustments of the controller 112 signal reactive protocols to that information would remain intact until and unless at least one of the bathroom 216 or the bedroom 214 access detectors 226 is traversed, and unless such a traversal occurs, the occupancy of the floor plan 210 is confirmed to be ongoing. Analogously, when occupation of the bedroom 214 is confirmed as ongoing, the controller 112 can be “certain” that this occupancy status is continuing unless at least one of the bedroom 214 motion detectors 232 again detects motion, since the occupant cannot leave the bedroom 214 without moving.

When an aural reply to a query is appropriate and the controller 112 is merely sensing relatively indiscriminately for such an aural reply within a selected time window following the query, there is a possibility that a sound sensor 234 can detect a sound (such as thunder or a passing siren) that is not sourced by the occupant in response to the query. In order for the controller 112 to be able to distinguish whether or not a sound was sourced within the monitored space (floor plan 210), two or more (generally dispersed) sound sensors 234 are utilized. Comparisons between at least two of the sound sensors' 234 sensed sounds can reveal differences in how the sound was perceived according to differences in where, relative to the monitored space, each sound sensor 234 is disposed. Sound pressure levels attenuate with distance in known ways, for example, the Minnesota Pollution Control Agency (520 Lafayette Road, Saint Paul, Minn. 55155-4194) whose purview includes sound pollution has estimated that “when the distance is doubled from a line source the sound level decreases three decibels” (=50% reduction,) while “when the distance is doubled from a point source the sound level decreases six decibels” (approx. a 78% reduction.) If the distance attenuation is akin to a point source, which is likely when an occupant replies to a query by making a sound in the appropriate time window (it is assumed that it will regularly be sufficient for most purposes to allow a couple or more seconds at minimum for the reply to be made,) then there will be a substantial difference in the distance of the two sound sensors 234 from the sound source.

A typical location for the reply sound to be made from would be the vicinity of the tip of the place-marking arrow 254. From this location, the sound would travel more than twice as far to arrive at the farther bedroom 214 sound sensor 234 than traveled to reach the closer bedroom 214 sound sensor 234. According to accepted understanding of how this difference would affect the sound pressures received by each of the bedroom 214 sound sensors 234, this difference corresponds to greater than a 50% difference in received sound pressure which is identifiable and distinguishable from substantially smaller sound pressure differences. When the sound sensors sense sounds from exterior sources such as thunder in the appropriate sound time-window they can, for example, use comparisons of the received sound pressures to regularly distinguish them from the interior sourced sounds. This is due to the pervasive nature of the vast majority of the exterior sounds usually existing as a roughly ambient event, as well as their being experienced on the interior with the sound following a multitude of paths from the exterior to any particular interior point. It is substantially unlikely that any exterior sourced sound could effect a 50% difference in the sound pressures sensed by the bedroom 214 sound sensors 234. Since the distance the exterior sourced sound traveled to arrive at the house will likely dwarf any difference in interior path length to the two bedroom 214 sound sensors 234 (even if all paths were consistently always shorter for one bedroom 214 sound sensor 234 and shorter for the other), the sound pressure arriving at the two bedroom sensors will be closely comparable and hence distinguishable from the interior sourced sounds. Additionally, and as a confirming backup, differences in the time attenuation behavior of differently sourced sounds can be utilized. Exterior sourced sounds tend to be larger events (or they wouldn't be heard) that occur across spreads of many seconds, including echoes and other factors, by the time they reach an interior floor plan 210, while interior sounds tend to be shorter and more abrupt in their ending. It is a relatively straightforward matter for anyone of skill in the art to instruct the controller 112 to distinguish these behavioral differences and thus augment the exterior vs. interior sound distinguishing.

In view of the above, it will be seen that the various objects and features of the invention are achieved and other advantageous results obtained. The examples contained herein are merely illustrative and are not intended in a limiting sense.

What is claimed is:

1. A method of discerning and/or responding to occupancy conditions comprising the steps of:
providing receivability for a first occupancy event signal associated with a first occupiable area and effecting one or more signal reactive protocols;
capacitating one or more opportunities for interaction with potential occupants of the first occupiable area so that a realized interaction opportunity can engender one or more second occupancy event signals, wherein one or more of the signal reactive protocols are responsive to active signals, inactive signals, or both; and
responding to at least one of the second occupancy event signals by effecting one or more of the signal reactive protocols.

2. The method of discerning and/or responding to occupancy conditions according to claim 1, wherein one or more of the signal reactive protocols is reactive to one or more of the first signals, the second signals, and combinations of the first and second signals.

3. The method of discerning and/or responding to occupancy conditions according to claim 1, wherein one or more of the signal reactive protocols' reactivity to one or more of the first signals, the second signals, and combinations of the first and second signals is optionally modifiable.

4. The method of discerning and/or responding to occupancy conditions according to claim 3, wherein one or more of the first signals, the second signals, and combinations of the first and second signals can influence realizations of modifications to the protocols' signal reactivity.

5. The method of discerning and/or responding to occupancy conditions according to claim 1, wherein variations of the attributes of the first and/or second signals can modify the operation of one or more of the signal reactive protocols.

6. The method of discerning and/or responding to occupancy conditions according to claim 1, wherein the first and/or the second signals can affect one or more of the signal reactive protocols' reactivity to the first and/or second signals.

7. The method of discerning and/or responding to occupancy conditions according to claim 1, wherein the first and/or second occupancy event signals can influence the operativity of one or more of the signal reactive protocols.

8. The method of discerning and/or responding to occupancy conditions according to claim 7, wherein the first and/or second occupancy event signals can activate one or more of the signal reactive protocols.

9. The method of discerning and/or responding to occupancy conditions according to claim 1, further comprising the step of responding to the first occupancy event signals by engendering one or more of the signal reactive protocols.

10. The method of discerning and/or responding to occupancy conditions according to claim 1, wherein the first or second occupancy event signals can modify which signal reactive protocols are operationally responsive to the other occupancy event signals.

11. The method of discerning and/or responding to occupancy conditions according to claim 1, wherein a first signal reactive protocol capacitates one or more interaction opportunities differently when the first occupancy event signal is active than when it is inactive.

12. The method of discerning and/or responding to occupancy conditions according to claim 1, wherein a first signal reactive protocol, upon receiving a specific first occupancy event signal, selectively capacitates one or more specific interaction opportunities.

13. The method of discerning and/or responding to occupancy conditions according to claim 1 wherein, upon receiving active first occupancy event signals, a first signal reactive protocol discerns that the first occupiable area is potentially occupied and subsequently capacitates one or more interaction opportunities capable of confirming occupancy of the first occupiable area, said subsequent capacitating being optionally realizable after a period of inactive first occupancy event signals.

14. The method of discerning and/or responding to occupancy conditions according to claim 13, wherein a first capacitated interaction opportunity involves a query for the first occupiable area's potential occupants whose responses comprise the second occupancy event signals that can confirm occupancy of the first occupiable area.

15. The method of discerning and/or responding to occupancy conditions according to claim 14, wherein the receiving of the query response second occupancy event signals confirms occupancy of the first occupiable area and effects a second signal reactive protocol that maintains the occupancy confirmation when the first occupancy event signals are inactive following the query response.

16. The method of discerning and/or responding to occupancy conditions according to claim 15 wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals.

17. The method of discerning and/or responding to occupancy conditions according to claim 13, wherein a second interaction opportunity involves capacitating receipt of second occupancy event signals engendered by one or more detectors of traversal of one or more portals associated with the first occupiable area.

18. The method of discerning and/or responding to occupancy conditions according to claim 17 wherein, when occupancy of the first occupiable area is confirmed, the occupancy's confirmation is maintained while the second occupancy event signals associated with the first occupiable area portal traversal detectors are inactive.

19. The method of discerning and/or responding to occupancy conditions according to claim 18 wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals.

20. The method of discerning and/or responding to occupancy conditions according to claim 1 further comprising controlling one or more output signals with one or more of the signal reactive protocols.

21. The method of discerning and/or responding to occupancy conditions according to 1 further comprising the step of collecting, arranging, relaying, analyzing, and/or processing information related to one or more of the interaction opportunities, occupancy event signals' active and/or inactive occurrences, occupancy events, occupiable areas associated with occupancy event signals, signal reactive protocols, and responses to the signals.

22. A system for discerning and/or responding to occupancy conditions comprising:
a controller capable of both receiving a first occupancy event signal associated with a first occupiable area and effecting one or more signal reactive protocols that are responsive to active signals, inactive signals, or both;
wherein the controller can further (a) capacitate one or more opportunities for interaction with potential occupants of the first occupiable area so that a realized interaction opportunity can engender one or more second occupancy event signals, and (b) respond to at least one of the second occupancy event signals by effecting one or more of the signal reactive protocols.

23. The system for discerning and/or responding to occupancy conditions according to claim 22, wherein one or more of the signal reactive protocols is reactive to one or more of the first signals, the second signals, and combinations of the first and second signals.

24. The system for discerning and/or responding to occupancy conditions according to claim 22, wherein one or more of the signal reactive protocols' reactivity to one or more of the first signals, the second signals, and combinations of the first and second signals is optionally modifiable.

25. The system for discerning and/or responding to occupancy conditions according to claim 24, wherein one or more of the first signals, the second signals, and combinations of the first and second signals can influence realizations of modifications to the protocols' signal reactivity.

26. The system for discerning and/or responding to occupancy conditions according to claim 24, wherein variations of the attributes of the first and/or second signals can modify the operation of one or more of the signal reactive protocols.

27. The system for discerning and/or responding to occupancy conditions according to claim 24, wherein the first and/or the second signals can affect one or more of the signal reactive protocols' reactivity to the first and/or second signals.

28. The system for discerning and/or responding to occupancy conditions according to claim 22, wherein the first and/or second occupancy event signals can influence the operativity of one or more of the signal reactive protocols.

29. The system for discerning and/or responding to occupancy conditions according to claim 28, wherein the first and/or second occupancy event signals can activate one or more of the signal reactive protocols.

30. The system for discerning and/or responding to occupancy conditions according to claim 22, wherein the controller responds to the first occupancy event signals by engendering one or more of the signal reactive protocols.

31. The system for discerning and/or responding to occupancy conditions according to claim 22, wherein the first or second occupancy event signals can modify which signal reactive protocols are operationally responsive to the other occupancy event signals.

32. The system for discerning and/or responding to occupancy conditions according to claim 22, wherein a first signal reactive protocol capacitates one or more interaction opportunities differently when the first occupancy event signal is active than when it is inactive.

33. The system for discerning and/or responding to occupancy conditions according to claim 22, wherein a first signal reactive protocol, upon receiving a specific first occupancy event signal, selectively capacitates one or more specific interaction opportunities.

34. The system for discerning and/or responding to occupancy conditions according to claim 22, wherein upon receiving active first occupancy event signals, a first signal reactive protocol discerns that the first occupiable area is potentially occupied and subsequently capacitates one or more interaction opportunities capable of confirming occupancy of the first occupiable area, said subsequent capacitating being optionally realizable after a period of inactive first occupancy event signals.

35. The system for discerning and/or responding to occupancy conditions according to claim 34 wherein a first capacitated interaction opportunity involves a query for the first occupiable area's potential occupants whose responses comprise the second occupancy event signals that can confirm occupancy of the first occupiable area.

36. The system for discerning and/or responding to occupancy conditions according to claim 35, wherein the receiving of the query response second occupancy event signals confirms occupancy of the first occupiable area and effects a second signal reactive protocol that maintains the occupancy confirmation when the first occupancy event signals are inactive following the query response.

37. The system for discerning and/or responding to occupancy conditions according to claim 36, wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals.

38. The system for discerning and/or responding to occupancy conditions according to claim 34, wherein a second interaction opportunity involves capacitating receipt of second occupancy event signals engendered by one or more detectors of traversal of one or more portals associated with the first occupiable area.

39. The system for discerning and/or responding to occupancy conditions according to claim 38 wherein, when occupancy of the first occupiable area is confirmed, the occupancy's confirmation is maintained while the second occupancy event signals associated with the first occupiable area portal traversal detectors are inactive.

40. The system for discerning and/or responding to occupancy conditions according to claim 39, wherein receiving of active first occupancy event signals, when the confirmation of occupancy is being maintained, returns the first signal reactive protocol to discernment of potential occupancy of the first occupiable area and subsequent capacitation of one or more interaction opportunities capable of confirming occupancy of the first occupiable area, said subsequent capacitation being optionally realizable after a period of inactive first occupancy event signals.

41. The system for discerning and/or responding to occupancy conditions according to claim 22 wherein one or more output signals is controlled with one or more of the signal reactive protocols.

42. The system for discerning and/or responding to occupancy conditions according to claim 22 wherein information related to one or more of the interaction opportunities, occupancy event signals' active and/or inactive occurrences, occupancy events, occupiable areas associated with occupancy event signals, signal reactive protocols, and responses to the signals is collected, arranged, relayed, analyzed, and/or processed.

43. Computer-readable media having computer-useable instructions embodied thereon to perform a method of assessing events associated with usage of a monitored space, said method comprising:
instituting one or more assessment procedures responsive to precursor evidence of usage of one or more monitored spaces by being receptive to successor evidence of usage of at least one of the monitored spaces, said successor evidence comprising data capable of indicating either usage detected or usage undetected, said receptivity optionally occurring after a specifiable period;
receiving the data comprising the successor evidence; and
responding with one or more of the assessment procedures by assessing, from the data indicating either usage detected or undetected, events potentially associated with usage of monitored space.

44. Computer-readable media having computer-useable instructions embodied thereon to perform the method of assessing events associated with usage of a monitored space according to claim 43 wherein, when a first monitored space has evinced usage, said responding step further comprises (a) engendering a usage related interaction that establishes present usage occurrence, and (b) maintaining the assessment of present usage occurring until the successor evidence indicates one or both of:
(i) usage detected data; and
(ii) an interruption of usage not detected data continuity.

45. Computer-readable media having computer-useable instructions embodied thereon to perform the method of assessing events associated with usage of a monitored space according to claim 43 wherein, when a first monitored space has evinced usage, said responding step further comprises engendering a usage related interaction that can establish present usage occurrence.

46. Computer-readable media having computer-useable instructions embodied thereon to perform the method of assessing events associated with usage of a monitored space according to claim 45, wherein the successor evidence includes motion detection within the monitored space so that the assessment that usage is presently occurring is maintainable without need for further evidence until motion detection evidence reoccurs.

47. Computer-readable media having computer-useable instructions embodied thereon to perform the method of assessing events associated with usage of a monitored space according to claim 43 wherein, following precursor usage evidence, said responding step includes engendering an interaction involving a reply-inviting query for the usage source, such that a reply confirms present usage.

48. The computer-readable media having computer-useable instructions embodied thereon to perform the method of assessing events associated with usage of a monitored space according to claim 47, wherein (a) a first and a potential second sound sensor signal are respectively producible by spatially separated first and second sound sensors in response to a first sound event occurring in the monitored space, said first and second sound sensor signals' difference exceeding a first threshold only when the first sound event's source is within the monitored space, and (b) the first sound event qualifies as a query reply when it is a timely sound sourced from within the monitored space; and
further comprising the step of discerning, upon receiving a first sound sensor signal, whether a potential second sound sensor signal that differs from the first signal by more than the first threshold is received.

49. Computer-readable media having computer-useable instructions embodied thereon to perform the method of assessing events associated with usage of a monitored space according to claim 43 wherein, when present usage occurrence has been established, said responding step includes monitoring access to the monitored space, wherein continuing usage is confirmed until either or both of (a) data indicating traversal of one or more accesses is received, and (b) data indicating no traversal is not continuously received.

50. Computer-readable media having computer-useable instructions embodied thereon to perform the method of assessing events associated with usage of a monitored space according to claim 43, when sufficiently many producers of the precursor and successor evidence are available, wherein only selected partial portions of the available producers of the precursor and successor evidence can be activated, and/or the monitored space can be differentially demarcated so that the assessment procedures instituted and/or the assessing effected can assess events associated with selected subdivisions of the monitored space.

51. Computer-readable media having computer-useable instructions embodied thereon to perform the method of assessing events associated with usage of a monitored space according to claim 50, wherein the selecting of the partial portions of the evidence producers and/or the selecting of the subdivisions of the monitored space is effectible with a user interface, said interface being optionally configurable as a graphical user interface.

52. A grouping of one or more computer executables that assess events associated with usage of a monitored space comprising at least one each of:
an executable procedure responder to precursor evidence of usage of one or more monitored spaces by becoming receptive to successor evidence of usage of at least one of the monitored spaces, said successor evidence comprising data indicating usage either detected or undetected, said receptivity optionally occurring after a specifiable period; and
an executable procedure assessor that receives the successor evidence and assesses, from the precursor and successor evidence, the potential of events associated with usage of the monitored space.

53. The grouping of one or more computer executables that assess events associated with usage of a monitored space according to claim 52 wherein, when current usage is established, the responder continues the assessment that usage is current until the successor evidence evinces one or both of:
(i) usage detected data; and
(ii) an interruption of usage not detected data continuity.

54. The grouping of one or more computer executables that assess events associated with usage of a monitored space according to claim 52 wherein, following receipt of the precursor usage evidence, the responder engenders an interaction able to establish current usage.

55. The grouping of one or more computer executables that assess events associated with usage of a monitored space according to claim 52 wherein, following receipt of the precursor usage evidence, the responder engenders an interaction involving a reply-inviting query for the usage source, such that a reply confirms current usage.

56. The grouping of one or more computer executables that assess events associated with usage of a monitored space according to claim 55, wherein (a) the successor evidence comprises a first and a potential second sound sensor signal respectively producible by spatially separated first and second sound sensors in response to a first sound event occurring in the monitored space, said first and second sound sensor signals' difference exceeding a first threshold only when the first sound event's source is within the monitored space, and (b) the first sound event qualifies as a query reply when it is a timely sound sourced from within the monitored space; and
said assessor, upon receiving the first sound sensor signal, discerns whether the potential second sound sensor signal that differs from the first signal by more than the first threshold is received.

57. The grouping of one or more computer executables that assess events associated with usage of a monitored space according to claim 52, following establishment of current usage, wherein the assessor monitors access to the monitored space and confirms continuing current usage until either or both of (a) access occurs, and (b) an interruption of access continuously not occurring.

58. The grouping of one or more computer executables that assess events associated with usage of a monitored space according to claim 52, wherein the usage evidence is produced by one or more forms of occupancy detector, said detector forms including motion detector alternate options.

59. The grouping of one or more computer executables that assess events associated with usage of a monitored space according to claim 58 wherein, when current usage has been confirmed and then usage evidence from a detector of motion in the monitored space is subsequently received, the assessor then assesses that the usage of the monitored space is potential, but no longer confirmed.

60. A method of assessing events associated with an observed area comprising the steps of:
observing a first area sufficiently that occurrences of access to and/or from the first area are observed;
perceiving a first action event occurring in the first area and then effecting a first determination that a first action event source is in the first area when the first action event occurred; and, optionally,
maintaining the first determination that the first action event source is in the first area until a first observation of the first area access occurrence.

61. The method of assessing events associated with an observed area according to claim 60 further comprising, in response to the first observation, a step of effecting one or more device control protocols, said protocols generally including options for controlling first area devices.

62. The method of assessing events associated with an observed area according to claim 60 further comprising a step of exchanging the first determination for a second determination, upon occurrence of the first observation, wherein the second determination is that the first action event source is potentially in the first area.

63. The method of assessing events associated with an observed area according to claim 62 further comprising, once the exchange for the second determination has been effected, a step of capacitating one or more interactions with the first action event source, wherein optional variants for a first interaction include engendering one or more answerable queries for the potential occupant and one or more answers to the queries can inform regarding one or more of (a) the occupant's presence within the first area; (b) the occupant's intended manner of occupation of the first area; and (c) the occupant's preferred device control protocols to be effected in response to the assessed events.

64. The method of assessing events associated with an observed area according to claim 63, wherein the query is answerable with a timely sound event sourced from within the observed area, further comprising the steps of:
capacitating receptivity to a first and a potential second sound sensor signal that are respectively producible by spatially separated first and second sound sensors in response to a first sound event occurring in the observed area, said first and second sound sensor signals' difference exceeding a first threshold only when the first sound event's source is within the observed area; and
discerning, upon receiving the first sound sensor signal, whether the potential second signal that differs from the first by more than the first threshold is received.

65. The method of assessing events associated with an observed area according to claim 63, wherein the query can assume a variety of modes including sounds and visible device control affects such as blinking lights.

66. The method of assessing events associated with an observed area according to claim 64, wherein the occupant's query answer can assume a variety of modes including audible sounds such as speech, and action events such as effecting a detectable movement.

67. The method of assessing events associated with an observed area according to claim 66, wherein the occupant's query answer can involve options of producing one or more specifically differentiated sounds including one or more distinct control sounds which can convey correspondingly distinct answers.

68. A method of assessing events associated with an observed area comprising the steps of:
observing a first area sufficiently that occurrences of access to and/or from the first area are observed, and realizing a first observation that an initial first area access has occurred;
capacitating one or more opportunities for interaction, once the first observation is realized, wherein realizing an interaction entails engendering a first action event in the first area;
effecting a first determination that one or more occupants are in the first area when the first action event occurred; and, optionally,
maintaining the first determination that occupants are in the first area until a second observation of first area access.

69. The method of assessing events associated with an observed area according to claim 68, wherein optional variants for a first interaction opportunity include engendering one or more answerable queries for potential first area occupants so that one or more answers to the queries can inform regarding one or more of (a) the potential occupant's presence within the first area; (b) the potential occupant's intended manner of occupation of the first area; and (c) the potential occupant's preferred device control protocols to be effected in response to the assessed events.

70. The method of assessing events associated with an observed area according to claim 69, wherein the query is answerable with a timely sound event sourced from within the observed area, further comprising the steps of:
capacitating receptivity to a first and a potential second sound sensor signal that are respectively producible by spatially separated first and second sound sensors in response to a first sound event occurring in the observed area, said first and second sound sensor signals' difference exceeding a first threshold only when the first sound event's source is within the observed area; and
discerning, upon receiving the first sound sensor signal, whether the potential second signal that differs from the first by more than the first threshold is received.

71. The method of assessing events associated with an observed area according to claim 68, when at least partial mitigation of a barrier to an access suffices to realize the first observation and the first action event can include motion detection, wherein the step of maintaining the first determination is definite.

72. A controller suitable for attaining occupancy awareness utilizable for device control comprising:
processor-executable programming able to effect a multitude of controller states in response to received signals of events related to occupancy of a monitored space, including a first state corresponding to a subject being potentially within the monitored space, a second state corresponding to effecting opportunities for the subject to confirm presence in the monitored space, a third state corresponding to confirmation of the subject's presence in the monitored space; and, optionally, an initial state in which the controller is not aware of occupancy of the monitored space;
wherein changing the subject's presence in the monitored space engenders particular occupancy related event signals that are receivable by the controller which, when in the third state, maintains awareness of the subject's confirmed presence in the monitored space without further presence awareness attaining actions until receipt of the particular occupancy related event signals.

73. The controller suitable for attaining occupancy awareness utilizable for device control according to claim 72, wherein the programming can variously instruct the controller to output control signals including energization and de-energization signals when the controller assumes one or more of the first, second, third, and optionally, initial states.

74. The controller suitable for attaining occupancy awareness utilizable for device control according to claim 72, wherein a first particular signal generating occupancy related event is a motion detection.

75. The controller suitable for attaining occupancy awareness utilizable for device control according to claim 72, wherein a second particular signal generating occupancy related event is a detection of potential traversal of one or more monitored space portals.

76. The controller suitable for attaining occupancy awareness utilizable for device control according to claim 72, wherein a first effected opportunity for presence confirmation when the controller is in the second state involves the controller effecting a query challenge and being receptive to query responses from the subject such that the controller effects the third state upon receipt of appropriate occupancy related event signals indicating an appropriate subject response to the query challenge.

77. The controller suitable for attaining occupancy awareness utilizable for device control according to claim 76, when a first appropriate subject response entails a timely sound event sourced from within the monitored space and the second controller state is in effect, the processor-executable programming further effects:
capacitating receptivity to a first and a potential second sound sensor signal that are respectively producible by spatially separated first and second sound sensors in response to a first sound event occurring in the monitored space, said first and second sound sensor signals' difference exceeding a first threshold only when the first sound event's source is within the first monitored area; and
discerning, upon receiving the first sound sensor signal, whether the potential second signal that differs from the first by more than the first threshold is received.

78. The controller suitable for attaining occupancy awareness utilizable for device control according to claim 71 wherein, when in the initial state, the controller effects the first state in response to receipt of signals of events related to occupancy of the monitored space.

79. The controller suitable for attaining occupancy awareness utilizable for device control according to claim 72, wherein a first effected opportunity for presence confirmation when the controller is in the second state involves the controller effecting a query challenge, said query challenge optionally occurring after the controller has effected the first state for a specifiable period, and being receptive to query responses from the subject such that the controller effects the initial state when an appropriate subject presence confirming query response signal is not received.

80. A system for distinguishing sound events' occupancy implications comprising:
a signal comparator, a first sound sensor respondable to a first sound event detectable in a first monitored region and a second sound sensor separated from the first sound sensor;
wherein differences in the responses of the first and second sound sensors to the first sound event are determinable by the signal comparator to exceed a first threshold only when the first sound event's source occurs within the first region.

81. A system for assessing sound events' occupancy implications comprising:
a signal assessor receptive to a first and a potential second sound sensor signal that are respectively producible by spatially separated first and second sound sensors in response to a first sound event occurring in a first monitored area, said first and second sound sensor signals' difference exceeding a first threshold only when the first sound event's source is within the first monitored area;
wherein the assessor can discern, upon receiving the first sound sensor signal, whether the potential second signal that differs from the first by more than the first threshold is received.

82. The system for assessing sound events' occupancy implications according to claim 81, wherein the first threshold is selected so that the assessor can discern that the first sound event source is not within the first monitored area when the received second sound sensor signal does not differ from the first sound sensor signal by more than the first threshold.

83. The system for assessing sound events' occupancy implications according to claim 81 wherein, when the assessor is treating timely sound as a potential control sound response to a query of a potential occupant of the first monitored area, the assessor can avoid treating the first sound event as being sourced by the potential occupant of the first monitored area when the received second sound sensor signal does not differ from the first sound sensor signal by more than the first threshold.

84. The system for assessing sound events' occupancy implications according to claim 83, wherein the first sound event is timely when it occurs within a selected period of time following the query.

85. A method of assessing sound events' occupancy implications comprising the steps of:
capacitating receptivity to a first and a potential second sound sensor signal that are respectively producible by spatially separated first and second sound sensors in response to a first sound event occurring in a first monitored area, said first and second sound sensor signals' difference exceeding a first threshold only when the first sound event's source is within the first monitored area; and
discerning, upon receiving the first sound sensor signal, whether the potential second signal that differs from the first by more than the first threshold is received.

86. The method of distinguishing sound events' occupancy implications according to claim 85, wherein the first threshold is selected so that said discerning also recognizes that the first sound event source is not within the first monitored area when the received second sound sensor signal does not differ from the first sound sensor signal by more than the first threshold.

87. The method of distinguishing sound events' occupancy implications according to claim 85 wherein, when timely sound is treated as a potential control sound response to a query of a potential occupant of the first monitored area and the received second sound sensor signal does not differ from the first sound sensor signal by more than the first threshold, the first sound event is treated as being not sourced by the potential occupant of the first monitored area.

88. The method of distinguishing sound events' occupancy implications according to claim 87, wherein the first sound event is timely when it occurs within a selected period of time following the query.

89. A system for assessing events associated with an observed area comprising:
a first area observer that observes any access to and/or from the first area and realizes a first observation when a first area access occurs;
an interactor, optionally capacitated by realization of the first observation, that can realize an interaction when a first action event occurs in the first area; and
an assessor that can:
(a) effect a first determination of use of the first area when the first action event occurs, and optionally,
(b) maintain the first determination until a subsequent first observation.

90. The system for assessing events associated with an observed area according to claim 89, when at least partial mitigation of a barrier to first area access suffices to realize the first observation and the first action event can include motion detection, wherein the step of maintaining the first determination is definite.
